(19) United States
(12) Patent Application Publication
(10) Pub. No.: US 2002/0165725 A1
(43) Pub. Date: Nov. 7, 2002

(54) Providing automated warranty fulfillment functionality from a consumable

(76) Inventor: Rigby Jacobs Heusinkveld, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/848,695

(22) Filed: May 3, 2001

(51) Int. Cl. G06F 17/60

(52) U.S. Cl. 705/1

(57) ABSTRACT

The present invention provides information and functionality on a consumable used for some image forming device to preferably assist a user in appropriately completing any warranty fulfillment procedures related to the consumable. A preferred embodiment of the inventive system comprises memory disposed on the consumable along with an interface for facilitating communication between the consumable and some device. Prior to selling the consumable, warranty information is originally stored on the memory. Additionally, use data is obtained after the user installs the consumable. The system also includes a set of computer-executable code instructions for interacting with the user, wherein the code instructions use some of the fulfillment information selected from any one or more of the user's responses, the warranty information, and the use data to complete warranty requirements.

### RELATED APPLICATIONS

The present application is related to commonly assigned, co-pending U.S. Patent Application Serial No. [Attorney Docket No. 10007175-1], entitled, “PROVIDING USER-ACCESSIBLE INFORMATION FROM A CONSUMABLE;” U.S. patent application Ser. No. 09/480,545, entitled, “REDUNDANT REORDER PREVENTION FOR REPLACEABLE PRINTER COMPONENTS,” filed Jan. 10, 2000, which is a continuation in part of co-pending U.S. patent application Ser. No. 09/410,989, entitled, “METHOD AND APPARATUS FOR IDENTIFYING A SALES CHANNEL,” filed Oct. 1, 1999, the disclosures of which are hereby incorporated herein by reference.

### TECHNICAL FIELD

This invention generally relates to image forming and office automation devices and more particularly, to self-managing consumables for use in these devices which provide automated warranty fulfillment functionality to a consumable user.

### BACKGROUND

Image forming and office automation devices, such as facsimile machines, printers, copiers, and scanners, use any number of consumables, e.g., toner, ink, ribbon, photoconductor, developer, and the like. Such consumables typically perform correctly and do not generally cause frequent failure in the image forming or office automation system. However, there may be occasion in which a consumable is defective. Consumables manufacturers and recyclers typically warranty their products against defects for a certain period of time. Most warranty information, including warranty fulfillment information, typically comprises many numerous pieces of paper, whether loose, bound into a small booklet, or enclosed in a sealed plastic bag, and placed at the bottom of the box in which the consumable was packaged.

Few individuals have the storage facilities or the desire to keep every warranty for every consumer product they purchase. In many instances, the warranty information is thrown in the trash or recycling container along other shipping documentation instructions. If such a consumer does, in fact, experience a warranty-related problem with the consumable, the lack of any warranty fulfillment information may generally cause delays or difficulties for the consumer in seeking a replacement or a refund. Additionally, the lack of any warranty information may also discourage the consumer from pursuing an exchange or refund at all. While this may save the manufacturers and recyclers money, it also may generally prevent or delay the discovery of hidden problems in the design of the consumable or decrease the level of customer satisfaction. Additionally, if a consumer attempts to contact the manufacturer or recycler to determine the appropriate warranty fulfillment information, the costs involved with personal interaction with the customer may, in fact, be greater than the cost of a replacement consumable.

Methods have been implemented with regard to product registration that include automated registration processes connected with the installation procedure for software applications or of software drivers for purchased computer-related hardware. Such methods allow the user to automatically register through an Internet connection during the installation, or may alternatively provide means to automatically print a registration postcard. However, warranty fulfillment information has generally not been addressed in these procedures. Furthermore, consumables do not typically provide the same opportunity for automating such processes as the installation process is still generally a manual procedure.

Consumable manufacturers have begun to place consumable management electronics into the consumable. One such technology is described in commonly assigned, U.S. Pat. No. 5,930,553, entitled, “Image Forming and Office Automation Device Consumable with Memory,” the disclosure of which is hereby incorporated herein by reference. Consumables configured according to this technology incorporate memory which can generally store use information retrieved from the host system, such as a host computer connected to a printer or a fax machine. This information can generally be retrieved when the consumable is taken to a recycling center or back to the manufacturer. The information retrieved from the system generally allows consumable manufacturers to learn about the use and performance of the consumable in order to improve the useful life and quality of future consumable products. It also generally provides the ability for software updates to be stored on the consumable. The controlling software and drivers of the device or host system usually allows the consumable to update the existing drivers or control software.

However, current consumables do not specifically provide warranty fulfillment information and/or automation. It would therefore be advantageous to have a consumable with warranty management capabilities incorporated into the consumable and accessible by a user.

### SUMMARY OF THE INVENTION

The present invention is directed to a system and method for incorporating memory into an image forming consumable for providing information and functionality to preferably assist a user in appropriately completing any warranty fulfillment procedures related to the consumable. A preferred embodiment provides an automated warranty fulfillment system for consumables comprising a memory disposed on the consumable along with an interface for facilitating communication between the consumable and some device. Prior to selling the consumable, warranty information is originally stored on the memory. Additional use data is also obtained after the user installs the consumable. The system also includes a set of computer-executable code instructions for interacting with the user, wherein the code instructions use some of the fulfillment information selected from the user's responses, the warranty information, and the use data to complete warranty requirements.

### BRIEF DESCRIPTION OF THE DRAWING

FIG. 1 is a diagram illustrating a consumable configured according to a preferred embodiment of the present invention;

FIG. 2 is a diagram illustrating an alternative preferred embodiment of the present invention configured with a host general purpose computer;

FIG. 3 is a diagram illustrating another alternative preferred embodiment of the present invention configured with a self-contained image forming and/or office automation device/host system;

FIG. 4 is a flow chart illustrating the steps according to the preferred method of the present invention; and

FIG. 5 is diagram illustrating another alternative embodiment of the present invention configured to communicate completed warranty information over a data network.

### DETAILED DESCRIPTION

The present invention is directed to a system and method that incorporates memory into an image forming consumable for providing information and functionality to preferably assist a user in appropriately completing any warranty fulfillment procedures related to that consumable. A preferred embodiment of the present invention may store warranty fulfillment information, such as a place and/or date of purchase, and program instructions that use the warranty fulfillment information to assist the user in filling out any warranty claims. The inventive consumable would preferably be in communication with an image forming or office automation device such that the user may interact or access the warranty fulfillment capabilities through the device. In alternative embodiments, a user may preferably access the inventive system through a separate host system, such as a general purpose computer. Such a host system would preferably be connected to the image forming device in order to facilitate communication between the host system and the intelligence disposed on the consumable through the image forming device.

When a user requires access to the warranty information, the host system or image forming device preferably accesses and obtains the program instructions from the consumable to execute the automated warranty fulfillment process. Depending on the particular embodiment of the present invention, such computer-executable instructions may preferably be executed either by a processor within the host system or one within the image forming or office automation system itself. As the instructions are executed, warranty information is preferably obtained from the consumable memory and from interaction with the user. The automated process would, therefore, preferably assist the user in obtaining access to the benefits available under the warranty, including filling out any necessary forms and even preferably instructing a user of a place to take the defective consumable.

Existing consumables typically do not incorporate the functionality to actively assist a user in filling out or accessing warranty information. Intelligence is beginning to be designed into consumables, as previously mentioned with regard to U.S. Pat. No. 5,930,553. Additional advancements in consumable intelligence have also been included in the aforementioned commonly-assigned, co-pending U.S. patent application Ser. No. 09/480,545, entitled, “REDUNDANT REORDER PREVENTION FOR REPLACEABLE PRINTER COMPONENTS,” the disclosure of which is hereby incorporated herein by reference. In this co-pending application, the consumable automatically reorders a new consumable when it reaches a certain level. The automated system according to the application includes a reorder prevention system that prevents another consumable from being reordered if the levels in the current consumable are “increased,” such as by shaking a toner cartridge.

Additionally, in the aforementioned, concurrently-filed, commonly-assigned, co-pending U.S. Patent Application Ser. No. [Attorney Docket No. 10007175-1], entitled “PROVIDING USER-ACCESSIBLE INFORMATION FROM A CONSUMABLE,” the disclosure of which is hereby incorporated herein by reference, a consumable is disclosed which incorporates nonvolatile memory to store user-accessible relevant information relating to the consumable.

FIG. 1 illustrates a generic consumable configured according to a preferred embodiment of the present invention. Consumable 10 may be a toner cartridge, an ink 1 cartridge, a developer, or the like. In its basic form, consumable 10 preferably comprises housing 100, image forming material 101 contained within housing 100, nonvolatile memory 102, and consumable interface 103. Consumable 10 also includes on-board consumable management processor 104, which may perform diagnostic tests on consumable 10 and also may provide processing capabilities or higher level communication functionality with a connected image forming system or office automation device. It should be noted that the present invention is not limited to consumables containing processing functionality such as with consumable management processor 104.

During the manufacturing or recycling process, the manufacturer or recycler preferably stores warranty fulfillment functionality 105 onto nonvolatile memory 102. For example, as shown in FIG. 1, warranty fulfillment functionality 105 may preferably comprise such information as warranty data 105-1 and warranty fulfillment program 105-2. Warranty data 105-1 may preferably comprise items such as the date of purchase (as obtained from the user), the date of installation, the number of images formed with consumable 10, and the like. It may also generally include instructions on how to comply with the warranty, the warranty terms, and any warranty forms required to implement the warranty. Warranty fulfillment program 105-2 preferably comprises a series of software instructions or a program which uses warranty data 105-1 and interacts with the user to comply with the necessary requirements of the warranty.

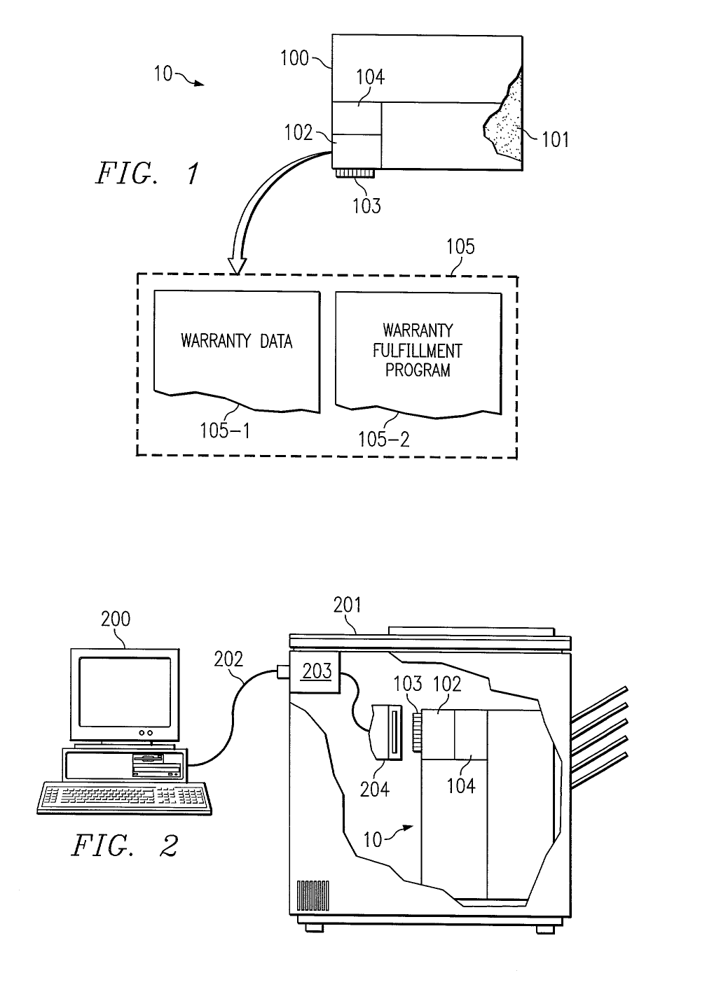

FIG. 2 illustrates the inventive consumable, consumable 10 in place in printer 201 (printer 201 is a partial cut-away illustration of a printer). Printer 201 is connected to computer 200 via printer cable 202. Consumable interface 103 connects with connector 204. This connection allows communication between print processor 203 of printer 201 and consumable 10. When a user at computer 200 desires to access the warranty fulfillment information preferably stored on nonvolatile memory 102, software within the printer driver on computer 200 may preferably initiate warranty fulfillment program 105-2 (FIG. 1).

In the embodiment shown in FIG. 2, warranty fulfillment program 105-2 (FIG. 1) runs locally on consumable management processor 104. The interactive portions of warranty fulfillment program 105-2 (FIG. 1) preferably get communicated to computer 200 for user input and to display warranty-related information to the user. Based on the information provided by the user and warranty data 105-1 (FIG. 1), warranty fulfillment program 105-2 (FIG. 1) selects the appropriate warranty form and fills out the form with the required information. If the warranty form must be delivered to the place of purchase, warranty fulfillment program 105-2 (FIG. 1) preferably signals print processor 203 to print a completed copy of the selected warranty form along with any available instructions for warranty returns. Each hard copy form would preferably be addressed to the appropriate entity using warranty data 105-1 (FIG. 1). Alternatively, warranty fulfillment program 105-2 (FIG. 1) may also preferably fill-out selected warranty forms for delivery to the manufacturer or recycler of the consumable, or preferably communicates with computer 200 to send the warranty information to the appropriate entity using the Internet or other electronic means.

In an alternative embodiment, consumable management processor 104 preferably has capabilities to perform consumable diagnostic testing. In such an embodiment, warranty fulfillment program 105-2 (FIG. 1) may first preferably interact with the user and the on-board diagnostic capabilities to determine if the problem experienced by the user is a warranty-related problem connected to consumable 10. This interactive diagnosis may preferably allow a user to determine that the consumable is, in fact, not defective, and that there may be a problem elsewhere in the system.

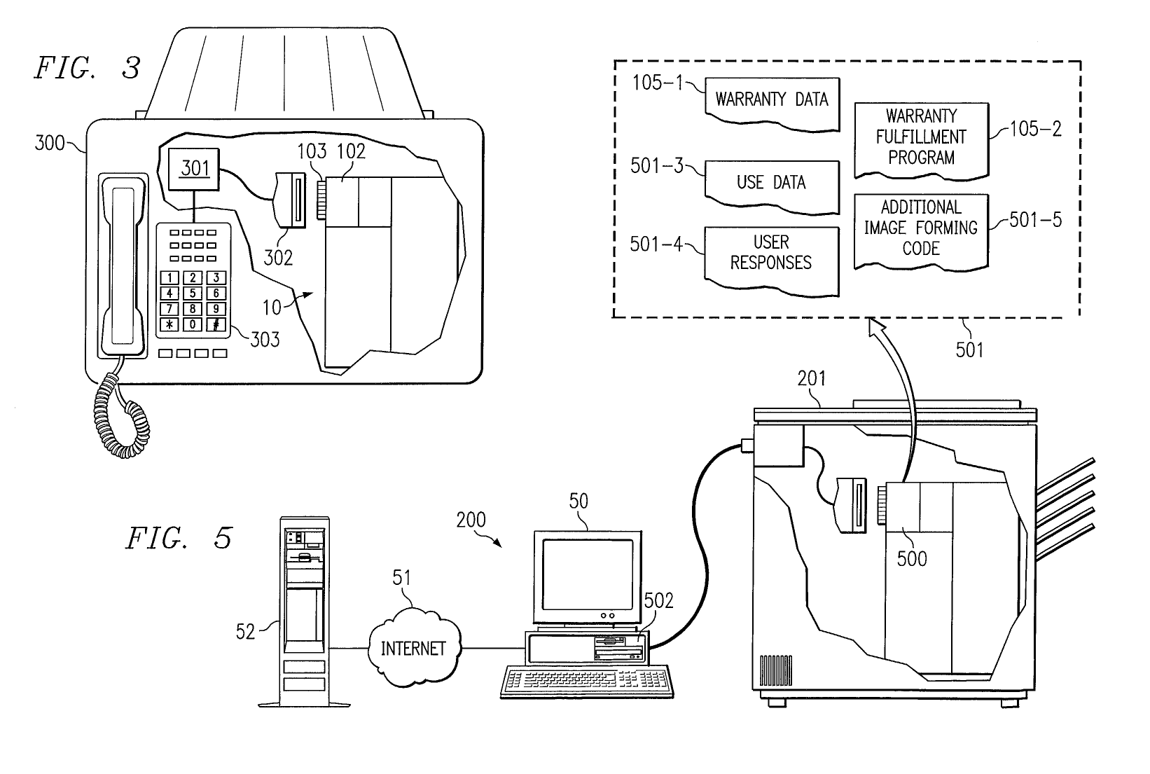

FIG. 3 illustrates an alternative, preferred embodiment of the present invention. Instead of a toner or ink cartridge for a printer, consumable 10 of FIG. 3 is a toner cartridge or developer for facsimile 300 (facsimile 300 is a partial cut-away illustration of a facsimile machine). When consumable 10 is inserted into facsimile 300, consumable interface 103 preferably forms an electrical connection with connector 302. Fax control software on fax processor 301 facilitates communication with nonvolatile memory 102 and also provides the control instructions for facsimile 300. Fax processor 301 generally executes the fax control software and provides the controlling electronics. If a user believes he or she needs to make a warranty claim on the consumable, warranty fulfillment program 105-2 (FIG. 1) may preferably be initialized by fax processor 302 through a series of keystrokes on keypad 303 entered by the user. In the embodiment shown in FIG. 3, program 105-2 (FIG. 1) is loaded from nonvolatile memory 102 to fax processor 302 for running. The user would then preferably interact with the warranty fulfillment process supplemented by warranty data 105-1 (FIG. 1) in order to complete any necessary warranty forms.

In the embodiment shown in FIG. 3, warranty fulfillment program 105-2 (FIG. 1) may preferably direct fax processor 301 to cause the completed warranty form to be faxed to the required destination as well as printing a copy for the user. Alternatively, if the user is required to send or deliver the consumable along with the completed warranty form, fax processor 301 would preferably prompt facsimile 300 to print the completed form along with any instructions for the user.

It will be appreciated that as the inventive consumable is inserted into an image forming device, such as printer 201 (FIG. 2) or facsimile 300 (FIG. 3), the technology disclosed in the aforementioned commonly assigned U.S. Pat. No. 5,930,553, entitled, “Image Forming and Office Automation Device Consumable with Memory,” the disclosure of which is hereby incorporated herein by reference, may be utilized to update the printer driver or fax control software to allow access to the warranty fulfillment information preferably stored on the memory. Thus, even devices manufactured prior to the implementation of the inventive method may take advantage of the novel technology described herein.

It should be noted that the present invention is not limited to application solely on printers and facsimile machines, as described above. Alternative embodiments of the present invention may be used on any variety of image forming or office automation equipment.

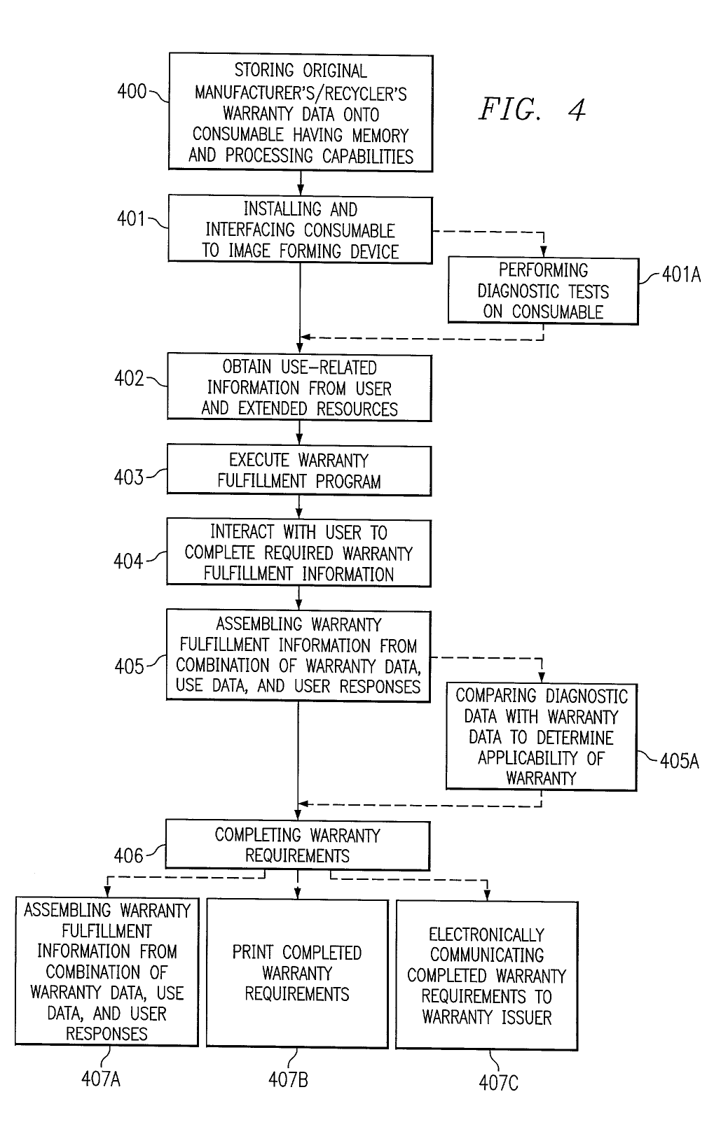

FIG. 4 presents a flowchart of the steps used to implement a preferred embodiment of the present invention. In step 400, the manufacturer or recycler preferably stores relevant warranty information onto the consumable's embedded memory. Such information may include the warranty terms, instructions on fulfilling the warranty, any required forms, and the like. The consumable is then installed and preferably interfaced with the image forming or office automation device in step 401. The installation and interface step preferably establishes a communication link between the inventive consumable and the image forming device. The communication may also preferably be extended to any host system, such as a general purpose computer, connected to the image forming device. However, in stand-alone devices, such as facsimile machines, copiers, scanners, and like devices, the image forming device may be a part of the overall host system.

In step 402, use-related information may preferably be obtained from the user and/or the device and/or the host system upon installation. Use-related information may preferably comprise the date of purchase, the place of purchase, date of first use, number of images formed, and other similar information. The use-related information is preferably obtained from the user and from the external resources of the image forming device and/or the host system. For example, the date of first use may preferably be noted from a system clock either in the image forming device or on the host system, while the number of images formed may be obtained from the image forming device.

If the user needs to access the warranty fulfillment process, the warranty fulfillment program is preferably executed in step 403. The warranty fulfillment program preferably interacts with the user in step 404 to obtain any further necessary warranty information used to complete required warranty forms. In step 405, all of the warranty fulfillment information and requirements are preferably assembled and combined from a selected combination of warranty data, use data, and user responses. When the correct information has been assembled, the warranty requirements and/or forms are preferably completed in step 406. Once the requirements and/or forms have been completed, several options or combinations of options are preferably available depending on the particular embodiment of the present invention implemented. In step 407A, the completed warranty fulfillment information is preferably presented to the user in some visual display. Additionally or alternatively, the warranty requirements and/or forms may preferably be printed for the user in step 407B. The user may then preferably use the completed form to return the defective consumable. Additionally or alternatively, the completed warranty requirements and/or information may be electronically communicated to the warranty issuer over the Internet or other data network in step 407C. Some embodiments may also provide for combinations of any or all of steps 407A - 407C.

It should be noted that in an alternative embodiment of the present invention may be configured to automatically activate the warranty fulfillment provisions if a diagnostic test indicates that a covered warranty problem is present.

It should further be noted that in other alternative embodiments, the inventive system would preferably perform diagnostic tests on the consumable to determine if anything was defective, in step 401A. When such an additional step is performed, the system would then preferably compare the results of the diagnostic tests with the warranty data to determine whether or not the warranty would be applicable, in step 405A.

FIG. 5 illustrates an alternative embodiment of the present invention configured to transmit the completed warranty information to a warranty issuer over the Internet. The illustrated system operates similarly to the system described in FIG. 2. In addition to warranty data 105-1, memory structure 501 on memory 500 includes user data 501-3 and user responses 501-4 to store the gathered use data and user responses as described above. When a user wishes to perform a warranty service, the user activates warranty fulfillment program 105-2 which takes selected data from any one or more of the data stored in warranty data 105-1, use data 501-3, and user data 501-4 and uses the selected data to complete the warranty requirements. When the warranty requirements have been completed, the completed information is then preferably communicated over Internet 51 to warranty issuer 52 for processing. In this operation, the user preferably does not have to print, mail, or otherwise physically send the completed warranty information to warranty issuer 52.

It should be noted that further embodiments of the present invention as described in FIG. 5 also preferably includes additional image forming code 501-5 which preferably allows the completed warranty information to be presented to the user on display 50 of computer 200. In such an embodiment, the user would preferably be allowed to edit or correct any mistakes in the completed warranty information before sending the information to warranty issuer 52. Although this further embodiment has been described with respect to the present invention as shown in FIG. 5, such alternative features may preferably be incorporated into any embodiment of the present invention.

It should be further noted that in other alternative embodiments of the present invention, the inventive system may use external memory, such as disk 502 to temporarily store any warranty fulfillment information. This embodiment is useful when a consumable is damaged or defective to the point where the information and functionality built into it cannot work. In such circumstances, the inventive system temporarily stores the required warranty information onto disk 502. When a new consumable is inserted, the functionality built into the new consumable executes warranty fulfillment program 105-2 which then retrieves the warranty information stored on disk 502 in order to complete the warranty requirements for the previous, defective consumable.

What is claimed is:

1. An automated warranty fulfillment system for consumables comprising:
a memory disposed on said consumable;
an interface for facilitating communication between said consumable and an device;
warranty information originally stored on said memory;
use data obtained after installation of said consumable; and
a set of computer-executable code instructions for interacting with a user, wherein said code instructions use fulfillment information selected from responses obtained from said user, said warranty information, and said use data to complete warranty requirements.

2. The system of claim 1 wherein consumable is an image forming consumable.

3. The system of claim 2 further comprising:
additional computer-executable code instructions for forming an image of said completed warranty requirements.

4. The system of claim 1 further comprising:
a processor disposed on said consumable for executing said set of computer-executable code instructions, wherein said executed instructions are communicated to said device over said interface.

5. The system of claim 1 wherein said user interacts with said automated warranty fulfillment system using a host system connected to said device.

6. The system of claim 5 wherein said host system comprises a general purpose computer.

7. The system of claim 1 wherein said set of computer-executable code instructions communicates said completed warranty requirements to a warranty issuer over a data network.

8. The system of claim 7 wherein said data network comprises the Internet.

9. A method for automating warranty fulfillment for a consumable comprising the steps of:
storing warranty data onto memory disposed on said consumable;
interfacing said consumable with a home device;
obtaining use-related information after installation of said consumable;
executing warranty fulfillment software disposed on said consumable memory;
prompting a user for warranty-relevant data;
assembling warranty fulfillment information from selected ones of said warranty data, said use-related information, and said warranty-relevant data; and
completing warranty requirements responsive to said assembling step.

10. The method of claim 9 further comprising the step of
connecting a host system to said device, wherein said prompting step is presented on a display of said host system.

11. The method of claim 9 further comprising the step of:
printing said completed warranty requirements.

12. The method of claim 9 further comprising the step of:
electronically communicating said completed warranty requirements to a warranty issuer.

13. The method of claim 9 further comprising the step of:
performing diagnostic testing on said consumable.

14. The method of claim 13 further comprising the step of:
comparing diagnostic information with said warranty data to determine applicability of said warranty.

15. The method of claim 9 further comprising the steps of:
temporarily storing said warranty data and said use-related information in an external memory when said consumable is inoperable.

16. The method of claim 15 further comprising the steps of:
executing warranty fulfillment software disposed on a memory of a new consumable; and
assembling said warranty fulfillment information from selected ones of said temporarily stored warranty data, said temporarily stored use-related information, and said warranty-relevant data obtained by said new consumable.

17. A consumable for a device comprising:
means for storing warranty terms on said consumable;
means for obtaining post-installation information regarding said consumable;
means for storing said post-installation information on said consumable;
means for interacting with a user for fulfilling consumable warranty requirements; and
means for completing warranty fulfillment information from at least one of:
said warranty terms;
said post-installation information; and
said means for interacting.

18. The consumable of claim 17 further comprising:
means for interfacing said consumable with said device.

19. The consumable of claim 17 further comprising:
means for communicating with a host system operated by said user.

20. The consumable of claim 17 further comprising:
means for forming an image of said completed warranty fulfillment information.

21. The consumable of claim 17 further comprising:
means for communicating said completed warranty fulfillment information to a warranty issuer.
